(19) United States
(12) Patent Application Publication
(10) Pub. No.: US 2025/0176458 A1
(43) Pub. Date: Jun. 5, 2025

(54) Row Unit for a Sowing Machine and Sowing Machine Having Row Units

(71) Applicant: Amazonen-Werke H. Dreyer SE & Co. KG, Hasbergen (DE)

(72) Inventors: Roland ARNOLD, Ganderkesee (DE); Jens KOCH, Uelzen (DE); Daniel MERTENS, Oldenburg (DE); Mario WESSELS, Ganderkesee (DE); Fabian DERTENKOETTER, Ostbevern (DE)

(73) Assignee: Amazonen-Werke H. Dreyer SE & Co. KG, Hasbergen (DE)

(21) Appl. No.: 18/840,129

(22) PCT Filed: Feb. 20, 2023
(86) PCT No.: PCT/EP2023/054124

§ 371 Date: Aug. 21, 2024

(30) Foreign Application Priority Data
Feb. 21, 2022 (DE) 10 2022 103 969.2

(51) Int. Cl. A01C 7/10; A01C 5/06

(52) U.S. Cl. CPC A01C 7/105; A01C 5/068

(57) ABSTRACT

RA row unit for a sowing machine, comprising a frame, a furrow opener mounted on the frame for opening a seed furrow, a seed depositing mechanism for depositing seed into the seed furrow, and a catching roller mounted on the frame for braking and/or pressing in seed deposited into the seed furrow. In order to enable the detection of a parameter related to the sowing of seed in row units having a catching roller it is provided that a sensor carrier is arranged on the frame directly behind the catching roller in the direction of travel (F) in such a way that it is carried in the seed furrow after the seed has been braked and/or pressed in, wherein the sensor carrier has at least one sensor for detecting at least one parameter related to the sowing of seed.

### Cross Reference to Related Applications

The present application claims priority under 35 U.S.C. § 365 to PCT/EP2023/054124 filed on Feb. 20, 2023 and under 35 U.S.C. § 119(a) to German Application No. 10 2022 103 969.2 filed on Feb. 21, 2022.

### BACKGROUND

The disclosure relates to a row unit for a sowing machine and to a sowing machine with a plurality of row units.

Row units for sowing machines are known which comprise a frame, a furrow opener mounted on the frame, a seed depositing mechanism and a catching roller mounted on the frame. During operation of such a row unit, the furrow opener opens a furrow in the soil into which seed is deposited by the seed depositing mechanism. The catching roller is used for braking and/or pressing in the seed deposited in the seed furrow. The seed furrow is closed again after the seed has been deposited to ensure good germination of the seed.

Other row units are known which have a sensor carrier for detecting parameters related to the sowing of seed. Since the sensor carrier is to be arranged in the seed furrow, it is usually provided instead of the catching roller. However, these row units subsequently show a poorer deposition of seed in the seed furrows.

### SUMMARY

It is therefore the object of the present disclosure to enable the detection of a parameter related to the sowing of seed in row units with a catching roller, which in particular have seed delivery mechanisms comprising a separating device operated by excess pressure.

It is provided that the row unit for a sowing machine comprises a frame, a furrow opener mounted on the frame, a seed depositing mechanism and a catching roller. The furrow opener is provided to open a seed furrow and can comprise two coulter disks that are arranged at an angle relative to each other. The row unit preferably further comprises a furrow former mounted on the frame, which is arranged in particular between the coulter disks in order to form the opened seed furrow. The seed depositing mechanism can be designed to precisely dispense seeds in a predetermined number of plants per unit of length. The seed depositing mechanism preferably comprises a separating device operated by excess pressure, which separates seeds by means of excess pressure and deposits them pneumatically accelerated in the seed furrow. A sensor carrier can be arranged on the frame directly behind the catching roller in the direction of travel in such a way that it can be carried in the seed furrow after the seed has been braked and/or pressed in, wherein the sensor carrier has at least one sensor for detecting at least one parameter related to the sowing of seed. The sensor carrier can be therefore arranged directly behind the catching roller, i.e., without any other elements in between in the direction of travel, so that it can run in the shadow of the catching roller in the seed furrow. The sensor carrier thus can be configured to detect in particular meaningful parameters directly at the site of seed deposition before the seed furrow closes. The row unit can include a closing unit for the seed furrow to cover the deposited and pressed in seed with soil. The closing unit is preferably arranged behind the sensor carrier in the direction of travel. The closing unit may comprise two furrow covering rollers arranged at an angle relative to each other. In this case, the arrangement of the sensor carrier directly behind the catching roller can be particular advantageous, as this creates space for the arrangement and function of the closing unit, wherein the row unit does not protrude too far to the rear in the direction of travel. After the seed has been braked and/or pressed in, i.e., in the direction of travel behind the seed grain that is just below the catching roller, the arrangement of the sensor carrier can be particular advantageous, as a good deposition of the seed can be first ensured before the detection of parameters related to the sowing of seed is accomplished. The catching roller can be configured to form the seed furrow. In particular, the catching roller can be designed to flex.

In an advantageous further embodiment of the row unit according to the disclosure, it is provided that the sensor carrier is arranged at least partially in front of a vertical plane in the direction of travel, which plane extends perpendicular to the direction of travel of the row unit and rests tangentially against the catching roller. The vertical plane can be located at the rear of the catching roller, in particular in the direction of travel. This area in front of the vertical plane is in particular useful for arranging the sensor carrier, as the catching roller still keeps the seed furrow open here. The sensor carrier therefore can be preferably arranged at least partially below the catching roller when viewed in the transverse direction, namely below the quadrant of the catching roller between the vertical plane and the contact point of the catching roller in the seed furrow. As a result of this further embodiment, the arrangement of the sensor carrier can be in particular space-saving, as the sensor carrier is arranged at least partially in the same installation space as the catching roller when viewed transversely to the direction of travel, so that the row unit does not project far to the rear.

In a further advantageous further embodiment of the row unit according to the disclosure, this comprises a closing unit in order to cover the seed furrow with soil and it is provided that the sensor carrier can be arranged in front of or directly adjoining a contact point of the closing unit in the direction of travel. The contact point of the closing unit defines the point as of which the seed furrow is closed again. Investigations have shown that, as a result of this further embodiment, the sensor carrier can detect particularly meaningful parameters, as the seed furrow is largely still in the same condition as when the seeds were planted. It is further advantageous that the sensor carrier thus generates the parameters at the final seed grain deposition depth generated by the catching roller and the detection is not disturbed by the already closing seed furrow.

In order to further advantageously develop the row unit according to the disclosure, the seed delivery mechanism can be configured to accelerate individual seed grains, wherein the direction of a flow of seeds from a seed outlet intersects a shell surface of the catching roller or rests essentially tangentially against the shell surface. The seed outlet may be arranged at the open end of a seed line, preferably with all seed grains in the seed line accelerated by the seed depositing mechanism. The acceleration of the seed grains can preferably be caused pneumatically, for which purpose the seed depositing mechanism may comprise a separating device operated by excess pressure. Alternatively, the acceleration can be caused by an ejector operated by excess pressure or vacuum.

For accelerated seed grains in particular, a catching roller has proven to be advantageous for braking and/or pressing in the seed, in particular compared to a sensor carrier. The sensor carrier therefore can be used only used directly behind the catching roller when the deposition has already been completed or the germination of the seed has been secured by the catching roller. Parameters relevant for sowing can therefore be detected directly on the braked and/or pressed in seed.

In a further advantageous embodiment of the row unit according to the disclosure, the sensor carrier is at a distance of less than 5 cm, preferably less than 3 cm, in particular preferably less than 1 cm, from the catching roller. The distance can be less than 5 cm perpendicular to a shell surface of the catching roller, preferably less than 3 cm, in particular preferably less than 1 cm. Investigations have shown that the seed furrow in this proximity to the catching roller is in particular suitable for being detected by the sensor carrier, as the furrow walls are swept over by the catching roller and thus homogenized, at least for a short time.

In order to be able to detect parameters relevant for sowing in an area that is in particular decisive for the seed, the sensor carrier can be arranged on the frame in such a way that an underside of the sensor carrier is in contact with a sole of the seed furrow and/or sweeps over braked and/or pressed in seeds. The horizon of the furrow bottom can thus be detected by at least one sensor of the sensor carrier and provide measured values that are particularly relevant. In addition, the seed grains deposited can be detected in order to check where and/or how regularly they have been placed and/or whether they have been pressed in correctly.

In a further advantageous embodiment of the row unit according to the disclosure, an elastic suspension device is provided, wherein the sensor carrier is arranged on the frame by way of the elastic suspension device. The sensor carrier is thus created with the possibility of adapting to the contour of the soil. The elastic suspension device can also serve as overload protection and thus protect the sensor carrier from damage. Alternatively, it would be conceivable to mount the sensor carrier rigidly on the frame.

In a further particularly advantageous embodiment of the row unit according to the disclosure, it is provided that the suspension device comprises a spring arm projecting downwards from the frame, the sensor carrier being mounted on the free end of the spring arm. The spring arm can be designed to be elastic so that it functions like a leaf spring. Alternatively, the spring arm can be rigid and rotatably arranged on the frame and/or on the sensor carrier, with the sensor carrier preferably being supported on the frame by a spring. The spring arm preferably protrudes diagonally forwards in the direction of travel to enable a collision-free arrangement very close to the catching roller. The spring arm holds the sensor carrier by pulling so that the sensor carrier can move backwards and upwards to overcome obstacles and there is no collision with the catching roller even in the event of an overload. The rear part of the sensor carrier can be lifted out when the front part hits an obstacle. A front part of the sensor carrier preferably has a higher hardness than a rear part of the sensor carrier in order to protect the sensor carrier from damage and wear in a simple manner. The spring arm is preferably essentially C-shaped, with in particular an upper leg of the C-shaped spring arm being mounted on the frame and a lower leg of the spring arm carrying the sensor carrier. The C-shape of the spring arm can be reproduced in the transverse direction if the direction of travel of the row unit is to the left. Alternatively, the spring arm can be aligned diagonally backwards and downwards from an axis of the catching roller in the direction of travel, wherein the spring arm can also have an essentially C-shaped form. The spring arm can alternatively implement a sliding reception of the sensor carrier.

In another particularly advantageous further embodiment of the row unit according to the disclosure, it is provided that the suspension device comprises a parallelogram with at least one spring element. The spring element can be designed as a coil spring and/or leaf spring. The parallelogram can be formed by two guide rods to which a spring element is assigned. The parallelogram can also be formed by spring elements themselves. Alternatively, the parallelogram can be formed by a guide rod and a spring element. The parallelogram arrangement allows the sensor carrier to be offset to the front, so that the sensor carrier can be carried particularly close to the catching roller. The parallelogram holds the sensor carrier by pressing so that the sensor carrier returns to its original position more quickly after overcoming an obstacle. Furthermore, the parallelogram arrangement offers the advantage that the sensor carrier can be kept parallel to the seed furrow or the sole of the seed furrow at all times, resulting in a permanent and uniform detection area for the sensors. This can increase the measuring accuracy.

In a further advantageous further embodiment of the row unit according to the disclosure, it is provided that the spring arm or the spring elements is or are pre-stressed in the direction of the seed furrow in order to hold the sensor carrier resiliently in contact with the seed furrow, and/or to hold the sensor carrier at a distance of less than 5 cm, preferably less than 3 cm, in particular preferably less than 1 cm, from the catching roller. The sensor carrier can thus be held resiliently in contact with the sole of the seed furrow. This can enable a reliable detection of parameters related to the sowing of seeds, even in changing soil conditions. The pre-stressing prevents the sensor carrier from losing contact with the seed furrow, while still ensuring that it can avoid obstacles.

The object of the disclosure is further achieved by a sowing machine with a plurality of row units, wherein the row units are designed according to at least one of the aforementioned embodiments. Please refer to the embodiments of the row unit for the advantages and modifications.

Further details of the disclosure can be found in the description of the example and the drawings. The drawings show

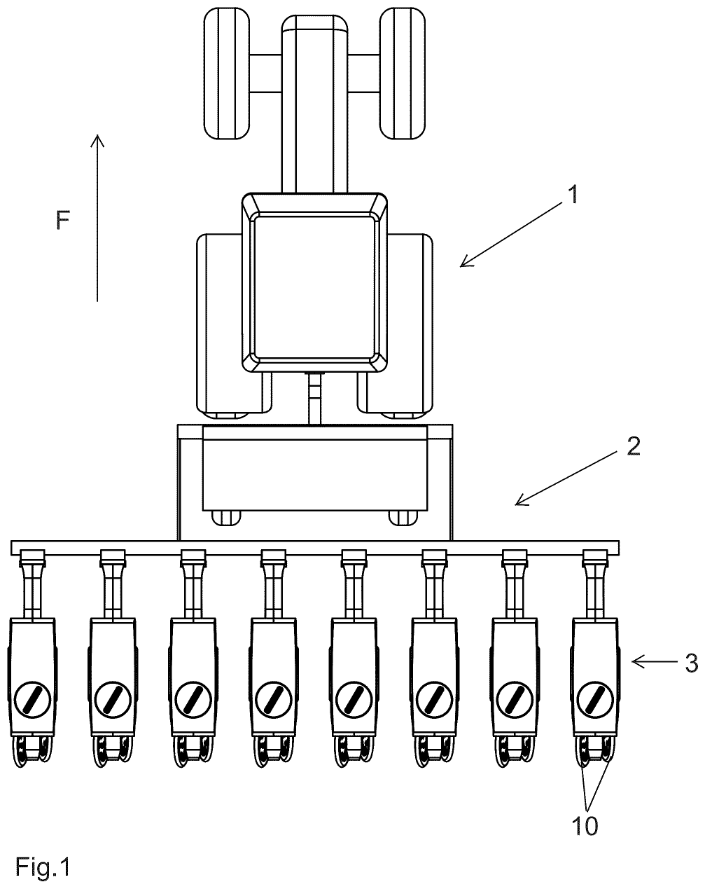

FIG. 1A top view of a machine combination comprising a tractor and a sowing machine according to the disclosure with a plurality of row units according to the disclosure,

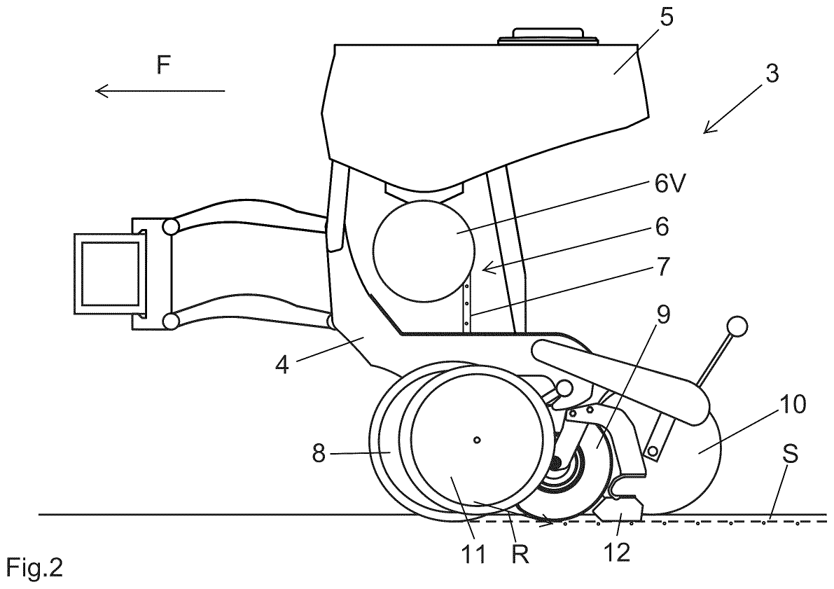

FIG. 2 An isolated side view of a row unit as shown in FIG. 1,

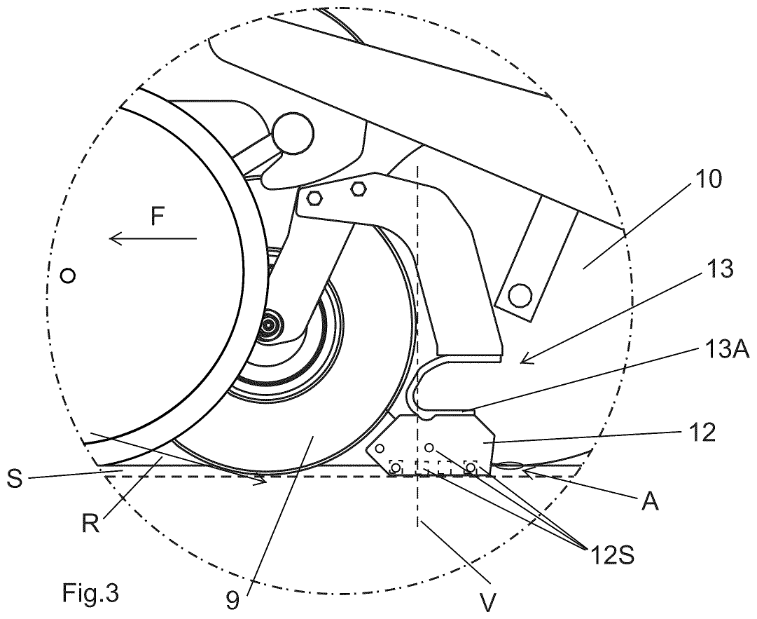

FIG. 3A detailed view of the row unit according to FIG. 2, and

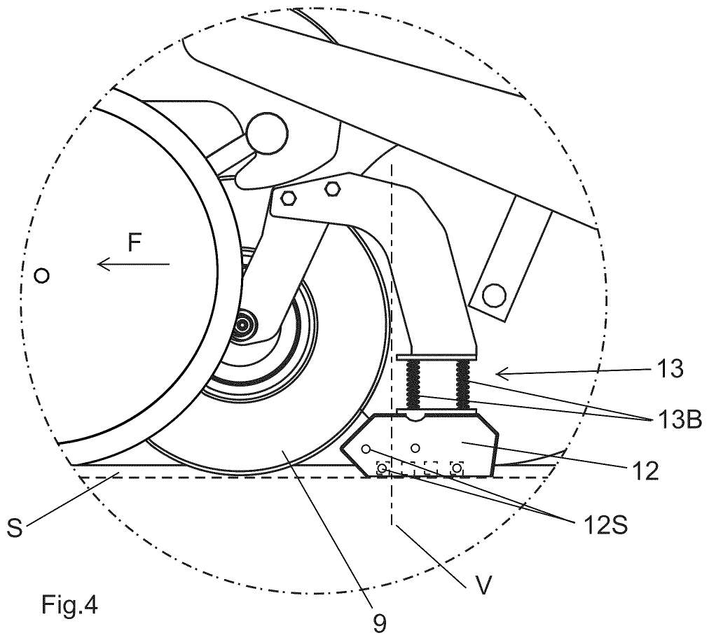

FIG. 4A detailed view of a further embodiment of the row unit.

A sowing machine 2 according to the disclosure attached behind a towing vehicle 1 is shown in FIG. 1. The sowing machine 2 and the towing vehicle 1 form a machine combination. The sowing machine 2 has a plurality of row units 3 at its rear end in the direction of travel F. The row units 3 are arranged transversely to the direction of travel F next to one another on a cross beam of the sowing machine 2 in order to plant so-called row crops.

One of the row units 3 is shown from the side, i.e. transverse to the direction of travel F, in FIG. 2 in a view isolated from the sowing machine 2. The row unit 3 comprises a frame 4, which provides the connection to the cross beam of the sowing machine 2 and on which all other components are mounted. Each row unit 3 has a storage container 5 for seed. The seed slides out of the storage container 5 into a seed depositing mechanism 6. The seed depositing mechanism 6 comprises a separating device 6V operated by excess pressure, which pneumatically separates seeds with the help of pressurized air and deposits them in an accelerated manner into a seed line 7. The separated seed can be deposited via the seed line 7 into a seed furrow S opened by furrow openers 8 mounted on the frame 4. The furrow openers 8 are formed by two coulter disks arranged at an angle to one another, which cut the seed furrows S into the soil. As the seed is accelerated by the separating device 6V, a catching roller 9 mounted on the frame 4 can be provided to brake the seed deposited in the seed furrow S and press it in the sole of the seed furrow S. At the rear of the row unit 3 in the direction of travel F, a closing unit designed as two furrow covering rollers 10 arranged at an angle to one another can be arranged on the frame 4 in order to close the seed furrow S again with the pressed in seed. The furrow covering roller 10 on the left as seen in the direction of travel F is dismantled in FIGS. 2 to 4 to provide a view of the other components.

The seed line 7 has a seed outlet at its open end that is covered by the furrow openers 8 and the associated pressure rollers 11. The direction R of the flow of accelerated seed grains exiting the seed outlet is tangential to a shell surface of the catching roller 9. Depending on the seed, the direction R can also intersect the shell surface of the catching roller 9. The row units 3 of the sowing machine 2 are thus configured to be used at high traveling speeds: The seed can be separated by the separating device 6V with excess pressure and deposited at an accelerated rate into the seed furrow S, where it is braked and pressed in by the catching roller 9. The catching roller 9 prevents the seed from bouncing and rolling, which accelerated seed grains otherwise tend to do. The seed depositing mechanism 6 thus can be configured to plant a predetermined number of plants per unit of length with the aid of the catching roller 9, even at high traveling speeds, as a high delivery frequency can be achieved due to the accelerated seed grains.

A sensor carrier 12 is arranged on the frame 4 directly behind the catching roller 9 in the direction of travel F in such a way that it can be supported in the seed furrow S after the seed has been braked and pressed in. No other components are arranged between the catching roller 9 and the sensor carrier 12. The sensor carrier 12 has a plurality of sensors 12S to detect various parameters related to the sowing of seeds. In order to provide in particularly meaningful data, the sensor carrier 12 can be guided in the seed furrow S. On the other hand, since the seed furrow S is closed again by the furrow covering rollers 10, the arrangement of the sensor carrier 12 directly behind the catching roller 9 can be particularly advantageous. The row unit 3 thus does not project far to the rear, as the furrow covering rollers 10, of which only one is shown in FIG. 2, can be arranged directly behind the sensor carrier 12 on the frame 4.

As FIG. 3 and FIG. 4 show, the sensor carrier 12 can be arranged partially in front of a vertical plane V in the direction of travel F, which plane extends perpendicular to the direction of travel F of the row unit 3 and rests tangentially against the rear end of the catching roller 9. The plane V therefore runs perpendicular to the image plane in FIGS. 3 and 4. In this area, the sensor carrier 12 can be at a distance of less than 1 cm from the shell surface of the catching roller 9. This has the advantage that the sensor carrier 12 with its sensors 12S runs in the shadow of the catching roller 9 in the seed furrow S. The sensor carrier 12 also can be arranged in the direction of travel F in front of or directly adjoining a contact point A of the closing unit designed as furrow covering rollers 10, so that the seed furrow S is closed again after the parameters relevant for sowing seed have been determined. The underside of the sensor carrier 12 always can be in contact with the sole of the seed furrow S and sweeps over the braked and pressed in seed grains.

FIG. 3 also shows a first embodiment of an elastic suspension device 13. The sensor carrier 12 is arranged on the frame 4 by means of the suspension device 13, which in this embodiment is designed as an elastic spring arm 13A. In an embodiment not shown, the sensor carrier 12 can alternatively be fastened via a rigid spring arm which is rotatably arranged on the frame, the sensor carrier being supported on the frame via a spring. The suspension device 13 secures the sensor carrier 12 against overload and can be configured to follow the contour of the soil. The spring arm 13A is essentially C-shaped and protrudes from the frame 4 downwards at an angle towards the front, with the sensor carrier 12 mounted on the free end of the spring arm 13A. By means of the spring arm 13A, the sensor carrier 12 can be held on the frame 4 by pulling, so that it can deflect away from the catching roller 9 to the rear, upwards. The spring arm 13A hereby acts as a kind of leaf spring. The spring arm 13 A can be pre-stressed in the direction of the seed furrow S in order to hold the sensor carrier 12 resiliently in contact with the sole of the seed furrow S. Furthermore, the distance of less than 1 cm to the catching roller 9 is thus maintained.

FIG. 4 shows a second embodiment of the elastic suspension device 13. The sensor carrier 12 here is mounted on the frame 4 via a parallelogram. The parallelogram can be formed here by two spring elements 13B. The spring elements 13B are designed as spiral springs and are offset backwards from the frame 4 on the sensor carrier 12, so that the sensor carrier 12 protrudes forwards. The spring elements 13B are also pre-stressed in the direction of the seed furrows S and hold the sensor carrier 12 resiliently in contact with the seed furrows S. The spring elements 13B arranged in the parallelogram hereby hold the sensor carrier 12 by pressing. In an embodiment not shown, the parallelogram can be formed from two guide rods instead of the spring elements 13B, whereby a spring element 13B is assigned to the guide rods.

### LIST OF REFERENCE SIGNS

1 Towing vehicle
2 Sowing machine
F Direction of travel
3 Row unit
4 Frame
5 Storage container
6 Seed dispensing mechanism
6V Separating device
7 Seed line
8 Furrow opener
S Seed furrow
9 Catching roller
10 Furrow covering roller
11 Pressure roller
R Direction (accelerated seed grains)
12 Sensor carrier
12S Sensor
v Vertical plane
A Contact point
13 Suspension device
13A Spring arm
13B Spring element

1. A row unit for a sowing machine, comprising:
a frame,
a furrow opener mounted on the frame for opening a seed furrow,
a seed dispensing mechanism for depositing seed into the seed furrow,
a catching roller mounted on the frame (4) for braking or pressing seed deposited in the seed furrow,
a sensor carrier is arranged on the frame directly behind the catching roller in a direction of travel such that it is carried in the seed furrow after the seed has been braked and/or pressed in, wherein the sensor carrier has at least one sensor for detecting at least one parameter related to the sowing of seed.

2. The row unit according to claim 1, wherein the sensor carrier is arranged at least partially in front of a vertical plane in the direction of travel, which plane extends perpendicular to the direction of travel of the row unit (3) and rests tangentially against the catching roller.

3. The row unit according to claim 1, a closing unit arranged on the frame in order to cover the seed furrow with soil, wherein the sensor carrier is arranged in front of or directly adjoining a contact point of the closing unit in the direction of travel.

4. The row unit according to claim 1, the seed delivery mechanism is configured to accelerate individual seed grains, wherein a direction of a flow of seeds from a seed outlet intersects a shell surface of the catching roller or rests essentially tangentially against the shell surface.

5. The row unit according to claim 1, characterized in that the sensor carrier is at a distance of less than 5 cm; from the catching roller.

6. The row unit according to claim 1, wherein the sensor carrier is arranged on the frame in such a way that an underside of the sensor carrier is in contact with a sole of the seed furrow and/or sweeps over braked and/or pressed in seed grains.

7. The row unit according to claim 1, characterized by an elastic suspension device, wherein the sensor carrier is arranged on the frame by way of the elastic suspension device.

8. The row unit according to claim 7, wherein the suspension device comprises an elastic spring arm which projects downwards from the frame preferably obliquely forward in the direction of travel, wherein the sensor carrier is mounted on the free end of the spring.

9. The row unit according to claim 7, wherein the suspension device comprises a parallelogram with at least one spring element.

10. The row unit according to claim 8, wherein the spring arm or the spring elements is/are pre-stressed in a direction of the seed furrow in order to hold the sensor carrier resiliently in contact with the seed furrow or to hold the sensor carrier at a distance of less than 5 cm from the catching roller.

11. A sowing machine with a plurality of row units wherein each of the plurality of row units comprise:
a frame;
a furrow opener mounted on the frame for opening a seed furrow;
a seed dispensing mechanism for depositing seed into the seed furrow;
a catching roller mounted on the frame for braking and/or pressing seed deposited in the seed furrow, and
a sensor carrier arranged on the frame directly behind the catching roller in a direction of travel such that it is carried in the seed furrow after the seed has been braked and/or pressed in, wherein the sensor carrier has at least one sensor for detecting at least one parameter related to the sowing of seed.

12. The row unit according to claim 5, wherein the sensor carrier is at a distance of less than 1 cm from the catching roller.
